(19) United States
(12) Patent Application Publication
(10) Pub. No.: US 2025/0370161 A1
(43) Pub. Date: Dec. 4, 2025

(54) INFORMATION PROCESSING APPARATUS AND COMPUTER-READABLE STORAGE MEDIUM

(71) Applicant: KABUSHIKI KAISHA TOSHIBA, Kawasaki-shi (JP)

(72) Inventors: Kazuya FUJII, Kawasaki Kanagawa (JP); Kazuya SAIMEI, Yokohama Kanagawa (JP); Takuma AKAGI, Tokyo (JP)

(73) Assignee: KABUSHIKI KAISHA TOSHIBA, Kawasaki-shi (JP)

(21) Appl. No.: 19/306,139

(22) Filed: Aug. 21, 2025

Related U.S. Application Data
(63) Continuation of application No. PCT/JP2024/005554, filed on Feb. 16, 2024.

(30) Foreign Application Priority Data
Feb. 21, 2023 (JP) 2023-025388

(51) Int. Cl. G01V 5/226; G01N 23/046

(52) U.S. Cl. CPC G01V 5/226; G01N 23/046

(57) ABSTRACT

An information processing apparatus capable of detecting a change in a content of an inspection target is provided. According to an embodiment, the information processing apparatus includes a communication interface, a memory, and a processor. The communication interface obtains feature information related to the content of the inspection target. The memory stores a database in which the feature information is registered. The processor determines whether or not the content has been changed based on the obtained feature information and the feature information registered in the database, and transmits change detection information indicating a result of the determination through the communication interface.

### CROSS REFERENCE TO RELATED APPLICATIONS

This application is a Continuation Application of PCT Application No. PCT/JP2024/005554, filed Feb. 16, 2024 and based upon and claiming the benefit of priority from Japanese Patent Application No. 2023-025388, filed Feb. 21, 2023, the entire contents of all of which are incorporated herein by reference.

### FIELD

Embodiments described herein relate to an information processing apparatus and a computer-readable storage medium.

### BACKGROUND

In an inspection site or the like, systems for inspecting whether or not a predefined target object (specific target object) such as a drug or a dangerous object is present in a parcel (inspection target) using an X-ray computed tomography (CT) apparatus are provided.

Conventional systems have a drawback in that they cannot detect a change in the contents of a parcel when an article is removed from or added to the inspection target after inspection is completed.

### BRIEF DESCRIPTION OF THE DRAWINGS

FIG. 1 is a diagram schematically showing an overall configuration of an inspection system that includes an inspection apparatus according to an embodiment.

FIG. 2 is a block diagram showing an example of a configuration of an information management system that includes the inspection apparatus according to the embodiment.

FIG. 3 is a block diagram showing an example of a configuration of control systems for an imaging apparatus and the inspection apparatus of the inspection system according to the embodiment.

FIG. 4 is a block diagram showing an example of a configuration of a host management apparatus in the information management system that includes the inspection apparatus according to the embodiment.

FIG. 5 is a diagram showing an example of an operation of the information management system according to the embodiment.

FIG. 6 is a diagram showing an example of an operation of the information management system according to the embodiment.

FIG. 7 is a flowchart showing an example of an operation of the inspection apparatus according to the embodiment.

FIG. 8 is a flowchart showing an example of an operation of the host management apparatus according to the embodiment.

FIG. 9 is a diagram showing another example of feature information according to an embodiment.

FIG. 10 is a diagram showing another example of feature information according to an embodiment.

### DETAILED DESCRIPTION

According to an embodiment, an information processing apparatus includes a communication interface, a memory, and a processor. The communication interface obtains feature information related to the content of an inspection target. The memory stores a database in which the feature information is registered. The processor determines whether or not the content has been changed based on the obtained feature information and the feature information registered in the database, and transmits change detection information indicating a result of the determination through the communication interface.

Hereinafter, embodiments will be described with reference to the drawings.

An information management system according to an embodiment inspects whether or not a predefined target object (specific target object) such as a drug or a dangerous object is present in the content of an inspection target such as a parcel. The information management system generates and displays an X-ray image showing the content of the inspection target using an inspection system. The information management system detects a change in the content of the inspection target based on the feature amount of the content of the inspection target.

For example, the information management system is used in an inspection site or the like in airports, harbors, customs offices, or the like.

The specific target object is assumed to be, for example, a dangerous article, a dangerous medicine, a prohibited drug, a substance that is prohibited from being brought into or taken out of predetermined areas, such as domestic zones, etc. The specific target object may not be a solid having a specific shape, and includes a substance such as a liquid or a powder.

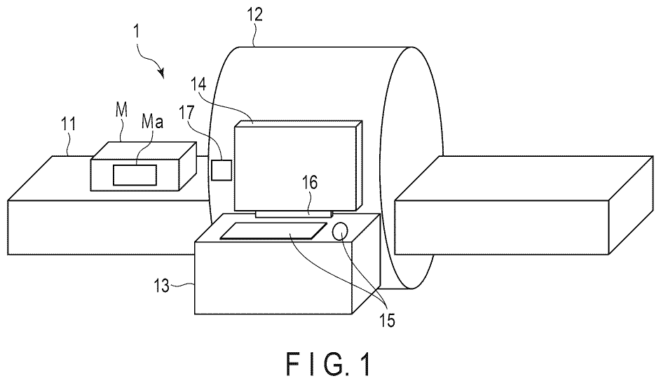

FIG. 1 is a diagram for schematically explaining an example of a configuration of an inspection system 1 that includes an inspection apparatus 13 according to an embodiment.

In the example of the configuration shown in FIG. 1, the inspection system 1 includes a conveyor 11, an imaging apparatus 12, an inspection apparatus 13, a display apparatus 14, an operation apparatus 15, a speaker 16, a reader 17, and the like. The inspection apparatus 13 is communicably connected to the imaging apparatus 12, the display apparatus 14, the operation apparatus 15, the speaker 16, the reader 17, and the like.

Here, the inspection system 1 inspects a parcel M, which is an inspection target.

A code Ma is attached to the parcel M. The code Ma is a code obtained by encoding an ID (identifier) for identifying the parcel M. For example, the code Ma is a barcode, a two-dimensional code, or the like. The code Ma is attached to the parcel M by a seal or the like.

The conveyor 11 is an apparatus for conveying the parcel M. The conveyor 11 conveys the parcel M subject to inspection to a position (reading position) where an image is captured by the imaging apparatus 12. For example, the conveyor 11 conveys the parcel M supplied by a worker. The conveyor 11 may be configured to convey the parcel M supplied by a robot arm or the like.

The imaging apparatus 12 irradiates the parcel M subject to inspection with electromagnetic waves (such as X-rays) and thereby obtains captured image data including a captured image of the inspection target and physical property information indicating physical properties of each part of the captured image. The imaging apparatus 12 supplies the captured image data of the parcel M to the inspection apparatus 13. The imaging apparatus 12 may obtain, as the captured image, two-dimensional image data or three-dimensional image data.

The imaging apparatus 12 is, for example, an X-ray CT imaging apparatus. The X-ray CT imaging apparatus as an example of the imaging apparatus 12 obtains three-dimensional X-ray image data as a captured image by irradiating the parcel M conveyed by the conveyor 11 with X-rays from the periphery of the parcel M. The X-ray CT imaging apparatus as the imaging apparatus 12 obtains captured image data including a three-dimensional X-ray image (captured image) of the parcel M and physical property information indicating physical properties of each constituent unit (pixel or voxel) constituting the X-ray image. The X-ray CT imaging apparatus as the imaging apparatus 12 supplies the captured image data obtained from the parcel M to the inspection apparatus 13.

Although the imaging apparatus 12 is not limited to the X-ray CT imaging apparatus, the description of the embodiment below is based on the assumption that the imaging apparatus 12 is the X-ray CT imaging apparatus.

The inspection apparatus 13 has various functions such as a function of processing an image of the parcel M captured by the imaging apparatus 12 using electromagnetic waves.

For example, the inspection apparatus 13 has a function of obtaining an image of the parcel M captured by the imaging apparatus 12 using electromagnetic waves and a function of outputting output information based on information obtained by a predetermined inspection process using an output device such as the display apparatus 14 or the speaker 16.

The inspection apparatus 13 also has a function of detecting a candidate (candidate target object) estimated as a specific target object present in the parcel M from the captured image data obtained from the imaging apparatus 12. The inspection apparatus 13 detects a candidate (candidate target object) estimated as a specific target object in the captured image of the parcel M obtained from the imaging apparatus 12 based on a value set based on the physical properties of the specific target object.

For example, the inspection apparatus 13 obtains the captured image data from the X-ray CT imaging apparatus as the imaging apparatus 12. The inspection apparatus 13 extracts the physical property information from the captured image data. The inspection apparatus 13 detects the candidate target object based on the physical property information. A pixel corresponds to a picture element that is a minimum unit constituting two-dimensional image data. A voxel is data for a minimum unit constituting three-dimensional data, and represents a value of a regular grid unit. A voxel is a value corresponding to a pixel in two-dimensional image data.

The inspection apparatus 13 has a function of detecting a specific portion or a specific object (hereinafter also simply referred to as a “specific part”) from a captured image of the parcel M. For example, the inspection apparatus 13 detects a specific part that is a specific portion or a specific object in an image captured by the imaging apparatus 12. The specific part is a portion or an object where specific target objects collected in advance are often hidden. The specific part may be a portion or an object having a predetermined shape, or a portion or an object in a predetermined position in the parcel. For example, shoes, a camera, a personal computer, a wall on a piece of luggage such as a trunk, a cigarette, and the like are assumed to be specific parts.

A specific part detector of the inspection apparatus 13 extracts an image of an area that is likely to be a portion or an object set (learned) in advance as a specific part from an image captured by the imaging apparatus 12, and detects the specific part by recognizing the shape of the extracted image. Specifically, the specific part detector of the inspection apparatus 13 can detect the specific part using semantic segmentation that associates a label or a category with all pixels in the captured image.

Note that the method of detecting the specific part applied to the specific part detector is not limited to the above-described method, and may be a method using general image recognition or object recognition such as machine learning using feature amounts of HOG (histograms of oriented gradients) features, etc., extracted from an image as an input, an SSD (Single Shot Detector, Single Shot MultiBox Detector) using deep learning, or the like.

The display apparatus 14 is an output device for notifying an inspector of a result of inspection. The display apparatus 14 displays a guide screen or the like under the control of the inspection apparatus 13. The display apparatus 14 displays a guide screen showing a result of an inspection process performed on a captured image of the parcel M, and the like, as a guide screen to be presented to an inspector. For example, the display apparatus 14 displays an image which clearly shows a candidate target object and a specific part in an image captured by the imaging apparatus 12 generated by the inspection apparatus 13.

The operation apparatus 15 generates an operation signal corresponding to an operation input of an inspector (operator), and supplies the operation signal to the inspection apparatus 13. The operation apparatus 15 is configured by operation devices such as a keyboard and a pointing device. The operation apparatus 15 may be configured by a touch panel or the like on a display screen of the display apparatus 14.

The speaker 16 is an output device for notifying an inspector of a result of inspection and the like by voice. The speaker 16 outputs a voice for notifying an inspector of voice guidance according to a result of an inspection process or the like.

The reader 17 reads the code Ma. The reader 17 transmits an ID obtained by decoding the code Ma to the inspection apparatus 13. The reader 17 may be fixed to the imaging apparatus 12 or the like, or may be a handy-type apparatus held by an operator. For example, the reader 17 is configured by a light that illuminates the code Ma, a camera that captures an image of the code Ma, and the like.

The inspection apparatus 13 has a function of performing an alert issuing process of notifying (issuing an alert to) an inspector of information on a candidate target object and the like. For example, the inspection apparatus 13 causes a candidate target object determined to be highly likely to be the specific target object to be displayed on the display apparatus 14 together with an image, captured by the imaging apparatus 12, of the parcel M conveyed by the conveyor 11.

In addition, the inspection apparatus 13 may cause all the candidate target objects in the captured image of the parcel M to be displayed on the display apparatus 14, and further cause a candidate target object determined to be highly likely to be the specific object to be displayed using a color, a mark, or the like different from those of the other candidates. The inspection apparatus 13 may cause an image that clearly shows each of the candidate target object and the specific part in the captured image of the parcel M to be displayed on the display apparatus 14. The inspection apparatus 13 may switch the content displayed on the display apparatus 14 according to an instruction from the operator through the operation apparatus 15.

Next, a configuration of an information management system 100 that includes the inspection system 1 according to the embodiment will be described.

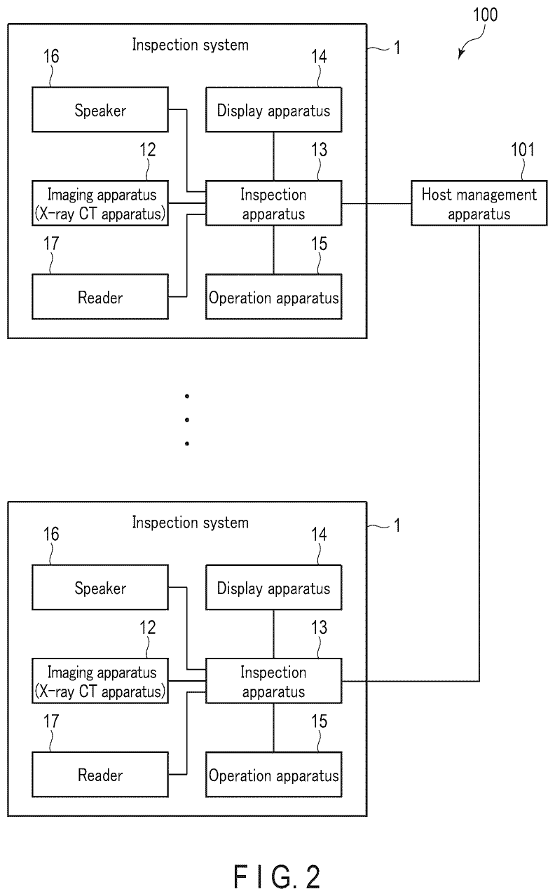

FIG. 2 is a diagram showing an example of a configuration of the information management system 100 that includes the inspection system 1 according to the embodiment.

As shown in FIG. 2, the information management system 100 includes a plurality of inspection systems 1 installed in each inspection site, and a host management apparatus 101 communicably connected to the inspection apparatuses 13 of the respective inspection systems 1.

Each inspection system 1 inspects the same parcel M. The inspection system 1 inspects the parcel M at each point on a route on which the parcel M is conveyed. For example, a predetermined inspection system 1 inspects the parcel M at the origin of conveyance of the parcel M. Another inspection system 1 inspects the parcel M at the destination of conveyance of the parcel M.

The host management apparatus 101 (information processing apparatus) functions as an information management apparatus that collects data from the inspection apparatuses of the inspection systems 1 and supplies data to the inspection apparatuses.

The host management apparatus 101 is, for example, configured by a computer such as a server apparatus. The host management apparatus 101 includes a storage apparatus that stores information relating to the inspection performed by the respective inspection systems 1. The host management apparatus 101 may include an interface connected to a server apparatus that stores information relating to the inspection.

The host management apparatus 101 obtains information from the inspection apparatuses 13 of the respective inspection systems 1. The host management apparatus 101 stores and aggregates information obtained from the inspection apparatuses 13 of the respective inspection systems 1. The host management apparatus 101 supplies information to the inspection apparatuses 13 of the respective inspection systems 1. For example, the host management apparatus 101 distributes a setting value or the like used for an inspection process to the inspection apparatuses 13 of the respective inspection systems 1. The host management apparatus 101 may distribute update data of a program for the respective inspection apparatuses 13 to perform the inspection process.

Next, a configuration of control systems for the imaging apparatus 12 and the inspection apparatus 13 of the inspection system 1 according to the embodiment will be described.

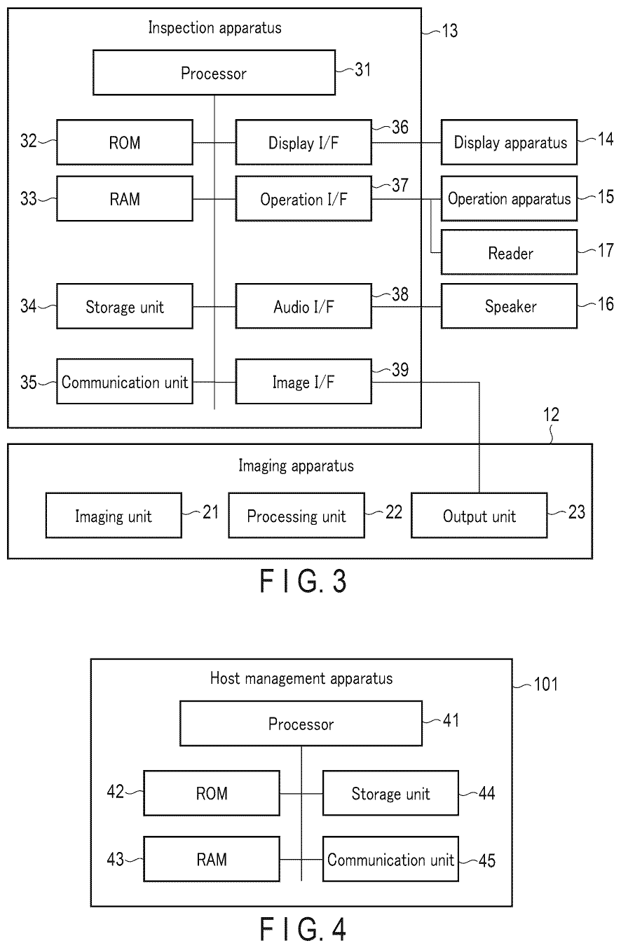

FIG. 3 is a block diagram showing an example of a configuration of control systems for the imaging apparatus 12 and the inspection apparatus 13 of the inspection system 1 according to the embodiment.

As shown in FIG. 3, the imaging apparatus 12 includes an imaging unit 21, a processing unit 22, and an output unit 23.

The imaging unit 21 irradiates an object subject to imaging such as the parcel M subject to inspection with electromagnetic waves such as X-rays to capture an image. For example, if the imaging apparatus 12 is an X-ray CT imaging apparatus, the imaging unit 21 obtains three-dimensional X-ray image data by irradiating the parcel M subject to inspection, which is conveyed by the conveyor 11, with X-rays from the periphery of the parcel M.

The processing unit 22 includes a processor, various memories, and the like, and performs various processes by the processor executing the programs stored in the memories. The processing unit 22 generates captured image data including a captured image and physical property information indicating physical properties in the constituent units (pixels or voxels) constituting the captured image by, for example, processing X-ray image data obtained via irradiation of electromagnetic waves by the imaging unit 21.

The output unit 23 is an interface that outputs data such as captured image data. The output unit 23 includes an interface corresponding to an image interface 39 of the inspection apparatus 13, and outputs the captured image data to the inspection apparatus 13. The output unit 23 may be an input-output interface including an interface for inputting data such as control data from the connected inspection apparatus 13.

As shown in FIG. 3, the inspection apparatus 13 includes a processor 31, a ROM 32, a RAM 33, a storage unit 34, a communication unit 35, a display interface 36, an operation interface 37, an audio interface 38, and an image interface 39.

The processor 31 performs a computing process. The processor 31 is, for example, a central processing unit (CPU). The processor 31 functions as a processing unit that performs various processes by executing the programs stored in the ROM 32 or the storage unit 34 using the RAM 33.

The ROM 32 is a read-only nonvolatile memory. The ROM 32 stores program data, control data, and the like. The RAM 33 is a volatile memory that functions as a working memory. The RAM 33 temporarily stores data.

The storage unit 34 is a rewritable nonvolatile memory. The storage unit 34 is configured by a hard disk drive (HDD), a solid state drive (SSD), or the like. The storage unit 34 stores information such as program data, a setting value as control data, and a result of an inspection process.

The storage unit 34 stores a bar graph database. The bar graph database will be described later.

The communication unit 35 is a communication interface for communicating with the host management apparatus 101. The processor 31 communicates with the host management apparatus 101 via the communication unit 35. The processor 31 transmits data such as a result of processing to the host management apparatus 101 via the communication unit 35, and receives data from the host management apparatus 101.

The display interface 36 is an interface for connecting to the display apparatus 14 as an output device. The display interface 36 may be any interface as long as it is compatible with the interface of the display apparatus 14. The processor 31 controls display content to be displayed on the display apparatus 14 via the display interface 36.

The operation interface 37 is an interface for connecting to the operation apparatus 15 and the reader 17. The operation interface 37 may be any interface as long as it is compatible with the interface of the operation apparatus 15 and the reader 17. The processor 31 obtains information input by the operation apparatus 15 and the reader 17 via the operation interface 37. The operation interface 37 may be configured by an interface for connecting to the operation apparatus 15 and an interface for connecting to the reader 17.

The audio interface 38 is an interface for connecting to the speaker 16 as an output device. The audio interface 38 may be any interface as long as it is compatible with the interface of the speaker 16. The processor 31 causes the speaker 16 as an output device to output a sound via the audio interface 38.

The image interface 39 is an interface for connecting to the imaging apparatus 12. The image interface 39 is an image obtaining unit (image obtaining interface) for obtaining captured image data from the imaging apparatus 12. The image interface 39 may be any interface as long as it is compatible with the interface of the imaging apparatus 12 such as an X-ray CT apparatus. The processor 31 obtains, via the image interface 39, captured image data including an image (X-ray image) captured by the X-ray CT apparatus as the imaging apparatus 12 and physical property information. The processor 31 may control the imaging operation of the imaging apparatus 12 on the parcel M via the image interface 39.

Next, a configuration of the host management apparatus 101 in the information management system 100 that includes the inspection system 1 according to the embodiment will be described.

FIG. 4 is a block diagram showing an example of a configuration of the host management apparatus 101 in the information management system 100 that includes the inspection system 1 according to the embodiment.

The host management apparatus 101 is an information management apparatus that manages information of the entire inspection system 1. The host management apparatus 101 is a computer that is communicably connected to the inspection apparatus 13 of the inspection system 1 installed in each inspection site. The host management apparatus 101 is configured by, for example, a server apparatus.

In the example of the configuration shown in FIG. 4, the host management apparatus 101 includes a processor 41, a ROM 42, a RAM 43, a storage unit 44, and a communication unit 45.

The processor 41 performs a computing process. The processor 41 is, for example, a central processing unit (CPU). The processor 41 functions as a processing unit that performs various processes by executing the programs stored in the ROM 42 or the storage unit 44 using the RAM 43.

The ROM 42 is a read-only nonvolatile memory. The ROM 42 stores program data, control data, and the like. The RAM 43 is a volatile memory that functions as a working memory. The RAM 43 temporarily stores data.

The storage unit 44 is a rewritable nonvolatile memory. The storage unit 44 is configured by a hard disk drive (HDD), a solid state drive (SSD), or the like. The storage unit 44 stores information such as program data, a setting value as control data, and data collected from each inspection apparatus 13.

The storage unit 44 stores a parcel information database in which parcel information is registered. The parcel information of the parcel M includes an ID of the parcel M, transfer origin information of the parcel M, and transfer destination information of the parcel M. The transfer origin information includes transfer origin consignor information, a transfer origin address, and transfer origin inspection site information. The transfer destination information includes transfer destination consignor information, a transfer destination address, and transfer destination inspection site information.

For example, the processor 41 of the host management apparatus 101 specifies the transfer destination inspection site of the parcel M from the parcel information database based on the ID of the parcel M as an inspection target transmitted from the inspection apparatus 13 in the transfer origin inspection site, and transmits the information obtained by the inspection apparatus 13 in the transfer origin inspection site to the inspection apparatus 13 in the transfer destination inspection site through the communication unit 45. The ID of the parcel M may include encoded transfer origin information and transfer destination information of the parcel M, and in this case, the processor 41 of the host management apparatus 101 specifies the transfer destination inspection site of the parcel M from the ID of the parcel M as an inspection target transmitted from the inspection apparatus 13 in the transfer origin inspection site.

The communication unit 45 is a communication interface for communicating with the inspection apparatuses 13 of the respective inspection systems 1. The processor 41 communicates with the inspection apparatuses 13 via the communication unit 45. The processor 41 receives data such as a result of processing from the inspection apparatuses 13 via the communication unit 45, and transmits data to the inspection apparatuses 13.

Next, the functions implemented by the inspection system 1 will be described. The inspection system 1 implements the functions by way of the processor 31 executing the program(s) stored in an internal memory, the ROM 32, the storage unit 34, or the like.

First, the processor 31 has a function of obtaining the ID of the parcel M.

For example, when the parcel M is loaded on the conveyor 11, the processor 31 drives the conveyor 11. When the parcel M reaches the reading position of the reader 17, the reader 17 reads and decodes the code Ma. When the code Ma is decoded, the reader 17 transmits the ID obtained by decoding to the inspection apparatus 13.

The processor 31 obtains the ID from the reader 17 through the operation interface 37.

If the reader 17 is a handy-type device, the operator holds the reader 17 over the code Ma. The reader 17 reads and decodes the code Ma. When the code Ma is decoded, the reader 17 transmits the ID obtained by decoding to the inspection apparatus 13.

The operator may visually check the ID of the parcel M and input the ID to the operation apparatus 15. In this case, the processor 31 obtains the ID from the operation apparatus 15 through the operation interface 37.

If no ID is set for the parcel M, the operator may issue an ID. In this case, the operator may attach the code Ma obtained by encoding the ID to the parcel M.

The processor 31 also has a function of obtaining captured image data from the imaging apparatus 12.

When the ID is obtained, the processor 31 continues to drive the conveyor 11 to cause the parcel M to pass through the imaging apparatus 12.

The imaging unit 21 of the imaging apparatus 12 generates X-ray image data by irradiating the parcel M with electromagnetic waves while the parcel M is passing. When the imaging unit 21 generates the X-ray image data, the processing unit 22 of the imaging apparatus 12 generates captured image data including a captured image and physical property information based on the X-ray image data. When the processing unit 22 generates the captured image data, the output unit 23 of the imaging apparatus 12 transmits the generated captured image data to the inspection apparatus 13.

The processor 31 obtains the captured image data from the imaging apparatus 12 through the image interface 39.

The processor 31 also has a function of causing the captured image to be displayed on the display apparatus 14 based on the captured image data.

When the captured image data is obtained, the processor 31 extracts a captured image from the captured image data. When the captured image is extracted, the processor 31 causes the captured image to be displayed on the display apparatus 14. The processor 31 may detect the candidate target object and the specific part from the captured image. The processor 31 may cause an image that clearly shows the candidate target object and the specific part in the captured image to be displayed.

The processor 31 also has a function of generating a bar graph of a substance constituting the parcel M.

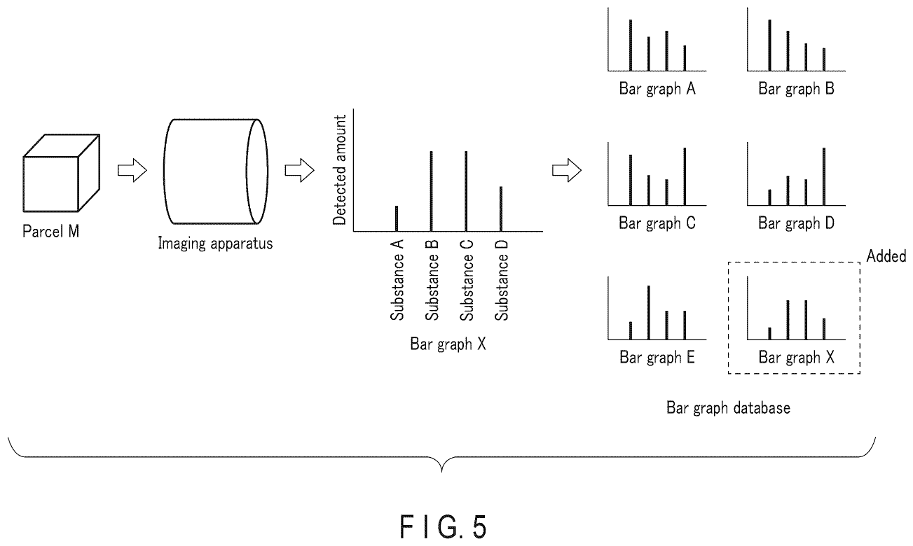

FIG. 5 shows an example of an operation in which the processor 31 generates a bar graph.

The processor 31 extracts the physical property information from the captured image data. Here, the physical property information indicates the density and the effective atomic number in each pixel or voxel. When the physical property information is extracted, the processor 31 specifies a substance included in each pixel or voxel based on the density and the effective atomic number in each pixel or voxel.

When a substance included in each pixel or voxel is specified, the processor 31 counts the pixels or voxels for each substance. That is, the processor 31 counts the pixels or voxels that includes the same substance.

When the pixels or voxels are counted for each substance, the processor 31 generates a bar graph (feature information) indicating the counted value (detected amount) for each substance. That is, the bar graph indicates the amount of each substance constituting the pixels or voxels of the parcel M.

In the example shown in FIG. 5, the processor 31 generates a bar graph X. As shown in FIG. 5, the horizontal axis of the bar graph X represents the substance. The vertical axis of the bar graph X represents the detected amount corresponding to the substance.

When the bar graph X is generated, the processor 31 transmits the ID and the bar graph X to the host management apparatus 101 through the communication unit 35 in a way that associates them with each other.

As described later, the host management apparatus 101 registers the ID and the bar graph X. If the ID and the bar graph X are already registered, the host management apparatus 101 transmits information (change detection information) indicating whether the content of the parcel M has been changed or not to the inspection apparatus 13.

If the processor 31 of the inspection apparatus 13 receives the change detection information, the processor 31 causes the change detection information to be displayed on the display apparatus 14. The processor 31 may output a warning sound or the like through the speaker 16 based on the change detection information.

Next, the functions implemented by the host management apparatus 101 will be described. The host management apparatus 101 implements the functions by way of the processor 41 executing the program(s) stored in an internal memory, the ROM 42, the storage unit 44, or the like.

First, the processor 41 has a function of registering the bar graph X in a bar graph database.

FIG. 5 shows an example of an operation in which the processor 41 registers the bar graph X in a bar graph database.

The bar graph database is a database that stores the ID of each parcel and the bar graph in a way that associates them with each other.

Here, the processor 31 of the inspection apparatus 13 that has inspected the parcel M first transmits the ID of the parcel M and the bar graph X to the host management apparatus 101 in a way that associates them with each other.

The processor 41 obtains the ID of the parcel M and the bar graph X from the inspection apparatus 13 through the communication unit 45. When the ID of the parcel M and the bar graph X are obtained, the processor 41 determines whether or not the obtained ID is registered in the bar graph database.

Here, the processor 41 determines that the obtained ID is not registered in the bar graph database.

When it is determined that the obtained ID is not registered in the bar graph database, the processor 41 registers the obtained ID and the bar graph X in the bar graph database in a way that associates them with each other.

When the obtained ID and the bar graph X are registered in the bar graph database in association with each other, the processor 41 may transmit a response indicating that the registration is completed to the inspection apparatus 13 through the communication unit 45.

The processor 41 also has a function of determining whether the content of the parcel M has been changed or not based on the bar graph X.

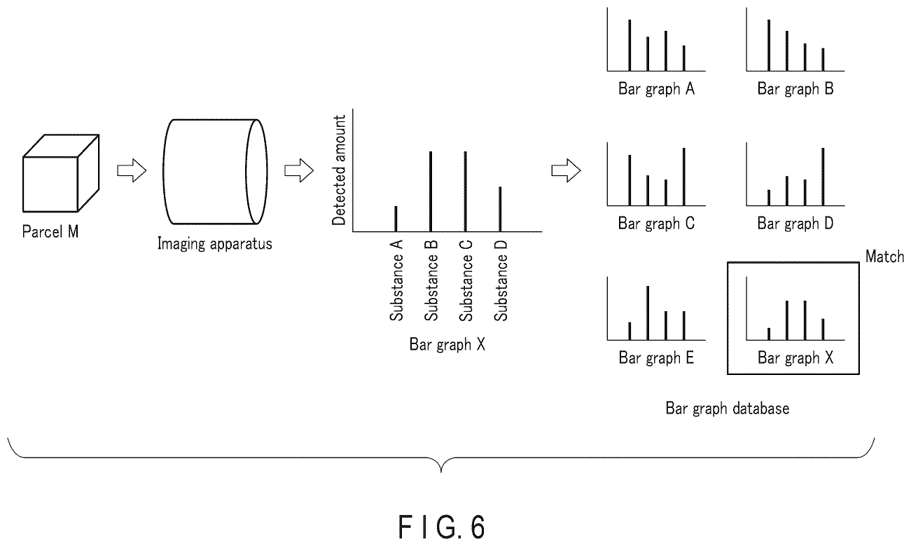

FIG. 6 shows an example of an operation in which the processor 41 determines whether or not the content of the parcel M has been changed.

Here, it is assumed that the bar graph database registers the ID of the parcel M and the bar graph X.

Also, the processor 31 of the inspection apparatus 13 that has inspected the parcel M on a further downstream side transmits the ID of the parcel M and the bar graph X to the host management apparatus 101 in a way that associates them with each other.

The processor 41 obtains the ID of the parcel M and the bar graph X from the inspection apparatus 13 through the communication unit 45. When the ID of the parcel M and the bar graph X are obtained, the processor 41 determines whether or not the obtained ID is registered in the bar graph database.

Here, the processor 41 determines that the obtained ID is registered in the bar graph database.

When it is determined that the obtained ID is registered in the bar graph database, the processor 41 obtains the bar graph X corresponding to the ID from the bar graph database.

When the bar graph X is obtained from the bar graph database, the processor 41 determines whether or not the bar graph X obtained from the inspection apparatus 13 and the bar graph X obtained from the bar graph database match each other.

For example, the processor 41 calculates a degree of similarity between the two in accordance with a predetermined algorithm. When a degree of similarity between the two is calculated, the processor 41 determines whether or not the degree of similarity is equal to or greater than a predetermined threshold. When it is determined that the degree of similarity is equal to or greater than the predetermined threshold, the processor 41 determines that the two match. When it is determined that the degree of similarity is less than the predetermined threshold, the processor 41 determines that the two do not match.

When it is determined that the two match, the processor 41 transmits change detection information indicating that the content of the parcel M has not been changed (change detection information indicating a result of the determination) to the inspection apparatus 13 through the communication unit 45.

When it is determined that the two do not match, the processor 41 transmits change detection information indicating that the content of the parcel M has been changed (change detection information indicating a result of the determination) to the inspection apparatus 13 through the communication unit 45.

Next, an example of an operation of the inspection apparatus 13 will be described.

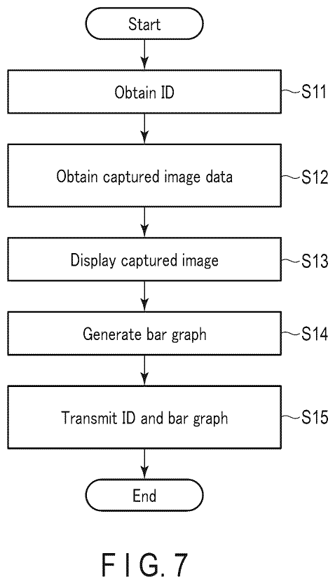

FIG. 7 is a flowchart for explaining an example of an operation of the inspection apparatus 13.

First, the processor 31 of the inspection apparatus 13 obtains the ID of the parcel M using the reader 17 (S11). When the ID is obtained, the processor 31 obtains captured image data of the parcel M using the imaging apparatus 12 (S12).

When the captured image data is obtained, the processor 31 causes the captured image to be displayed on the display apparatus 14 (S13). When the captured image is displayed, the processor 31 generates a bar graph X based on the captured image data (S14).

When the bar graph X is generated, the processor 31 transmits, through the communication unit 35, the ID and the bar graph X to the host management apparatus 101 in a way that associates them with each other (S15).

When the ID and the bar graph X are transmitted to the host management apparatus 101 in association with each other, the processor 31 ends the operation.

Next, an example of an operation of the host management apparatus 101 will be described.

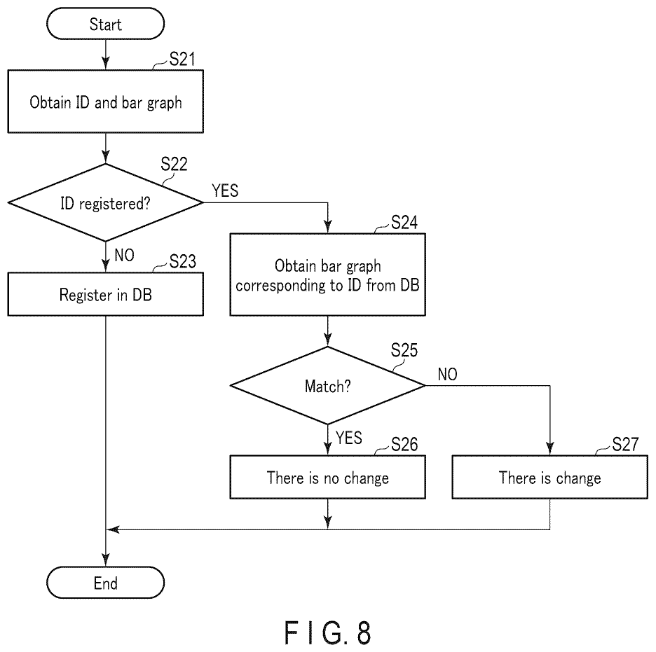

FIG. 8 is a flowchart for explaining an example of an operation of the host management apparatus 101.

First, the processor 41 of the host management apparatus 101 obtains the ID and the bar graph X from the inspection apparatus 13 through the communication unit 45 (S21). When the ID and the bar graph X are obtained, the processor 41 determines whether or not the obtained ID is registered in the bar graph database (S22).

When it is determined that the obtained ID is not registered in the bar graph database (S22, NO), the processor 41 registers the obtained ID and bar graph X in the bar graph database in a way that associates them with each other (S23).

When it is determined that the obtained ID is registered in the bar graph database (S22, YES), the processor 41 obtains the bar graph X corresponding to the obtained ID from the bar graph database (S24).

When the bar graph X is obtained from the bar graph database, the processor 41 determines whether or not the bar graph X obtained from the inspection apparatus 13 matches the bar graph X obtained from the bar graph database (S25).

When it is determined that they match (S25, YES), the processor 41 transmits, to the inspection apparatus 13 through the communication unit 45, change detection information indicating that the content of the parcel M has not been changed (S26).

When it is determined that they do not match (S25, NO), the processor 41 transmits, to the inspection apparatus 13 through the communication unit 45, change detection information indicating that the content of the parcel M has been changed (S27).

If the obtained ID and bar graph X are registered in the bar graph database in association with each other (S23), if the change detection information indicating that the content of the parcel M has not been changed is transmitted to the inspection apparatus 13 (S26), or if the change detection information indicating that the content of the parcel M has been changed is transmitted to the inspection apparatus 13 (S27), the processor 41 ends the operation.

The information management system 100 may inspect the parcel M three or more times. In this case, the information management system 100 determines whether or not the content of the parcel M has been changed in the second and subsequent inspections.

The inspection apparatus 13 may transmit information other than the bar graph as feature information.

The processor 41 of the host management apparatus 101 may transmit the ID and the feature information of the parcel M received from the inspection apparatus 13 in the transfer origin inspection site of the parcel M to the inspection apparatus 13 in the transfer destination inspection site of the parcel M through the network connected to the inspection apparatus 13 in the transfer destination inspection site of the parcel M. The processor 41 specifies the transfer destination inspection site of the parcel M from the parcel information database based on the ID of the parcel M as an inspection target transmitted from the inspection apparatus 13 in the transfer origin inspection site. The parcel information database includes parcel information related to the parcel M, and the parcel information includes the ID and the transfer destination information of the parcel M. Alternatively, if the ID of the inspection target includes coded transfer destination information of the parcel M, the processor 41 specifies the transfer destination inspection site of the parcel M included in the ID of the inspection target.

The processor 31 of the inspection apparatus 13 in the transfer destination inspection site of the parcel M receives the ID and the feature information of the parcel M transmitted from the host management apparatus 101 through the communication unit 35. The processor 31 registers the received ID and feature information in the database of the storage unit 44. The processor 31 registers the feature information generated from the information captured by the imaging apparatus 12 in the transfer destination inspection site in the database of the storage unit 44. The processor 31 compares the received feature information of the parcel M (the state of the parcel M in the transmission origin inspection site) with the generated feature information of the parcel M (the state of the parcel M in the transmission destination inspection site), determines whether or not the content of the parcel M has been changed, and transmits change detection information indicating the result of the determination to the host management apparatus 101.

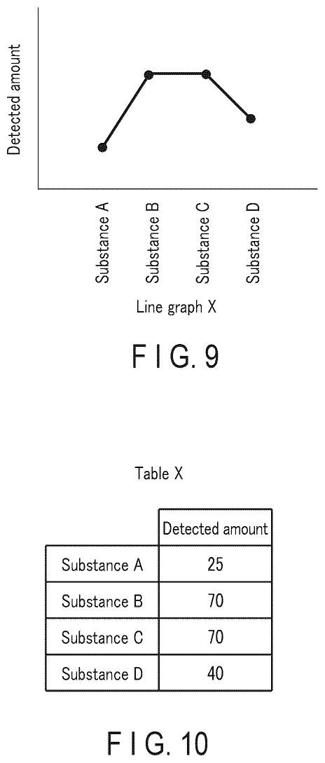

FIG. 9 shows another example of the feature information. As shown in FIG. 9, the feature information may be a line graph. Here, the horizontal axis represents a substance. The vertical axis represents the detected amount corresponding to the substance.

Also, FIG. 10 shows still another example of the feature information. As shown in FIG. 9, the feature information may be a table. Here, the table shows the detected amount of each substance.

The processor 31 of the inspection apparatus 13 may calculate a feature amount of the captured image data according to a predetermined algorithm, and generate feature information indicating the feature amount.

The configuration of the feature information is not limited to a specific configuration.

The processor 41 of the host management apparatus 101 may generate a bar graph (feature information). In this case, the processor 41 obtains the captured image data from the inspection apparatus 13. The processor 41 generates a bar graph from the captured image data.

The information management system configured as described above generates a bar graph relating to the content of a parcel based on a result of an inspection obtained by inspecting the parcel with X-rays. The information management system likewise generates a bar graph on the downstream side of a route on which the parcel is conveyed. If the two bar graphs do not match, the information management system determines that the content of the parcel has been changed. As a result, the information management system can detect that the content of the parcel has been changed after the inspection of the parcel.

The program according to the embodiments may be transferred in the state of being stored in an electronic device or transferred in the state of not being stored in an electronic device. In the latter case, the program may be transferred through a network or may be transferred in a state of being stored in a storage medium. The storage medium is a non-transitory tangible medium. The storage medium is a computer-readable medium. The storage medium may be of any type, such as a CD-ROM or a memory card, as long as it can store programs and can be read by the computer.

While certain embodiments have been described, they have been presented by way of example only, and they are not intended to limit the scope of the inventions. The novel embodiments described herein can be implemented in a variety of other forms; furthermore, various omissions, substitutions, and changes can be made without departing from the spirit of the invention. The accompanying claims and their equivalents are intended to cover such embodiments or modifications as would fall within the scope and spirit of the inventions.

What is claimed is:

1. An information processing apparatus comprising:
a communication interface for obtaining feature information related to a content of an inspection target;
a memory for storing a database in which the feature information is registered; and
a processor configured to:
determine whether or not the content has been changed based on the obtained feature information and the feature information registered in the database; and
transmit change detection information indicating a result of the determination through the communication interface.

2. The information processing apparatus according to claim 1, wherein the feature information is generated based on data obtained by irradiating the inspection target with X-rays.

3. The information processing apparatus according to claim 2, wherein the feature information is generated based on a density and an effective atomic number of the inspection target.

4. The information processing apparatus according to claim 3, wherein the feature information indicates a substance specified based on the density and the effective atomic number of the inspection target.

5. The information processing apparatus according to claim 4, wherein the feature information is a bar graph indicating an amount of each substance constituting each pixel or voxel of the inspection target.

6. The information processing apparatus according to claim 1, wherein the processor is configured to:
transmit the change detection information indicating that the content has not been changed through the communication interface if the obtained feature information matches the feature information registered in the database; and
transmit the change detection information indicating that the content has been changed through the communication interface if the obtained feature information does not match the feature information registered in the database.

7. The information processing apparatus according to claim 1, wherein
the database registers an ID of the inspection target and the feature information such that they are associated with each other,
the communication interface obtains the ID and the feature information, and
the processor registers the ID and the feature information obtained in the database such that they are associated with each other if the ID is not registered in the database.

8. The information processing apparatus according to claim 1, wherein
the database registers an ID of the inspection target and the feature information such that they are associated with each other,
the communication interface obtains the ID and the feature information, and
the processor transmits the ID and the feature information to an inspection apparatus in a transfer destination inspection site related to the ID through a network connected between the processor and the transfer destination inspection site.

9. The information processing apparatus according to claim 1, wherein the inspection target is a parcel.

10. A computer-readable storage medium which is a non-transitory computer-readable storage medium storing a program for execution by a processor,
the program causing the processor to perform:
a function of obtaining feature information related to a content of an inspection target;
a function of determining whether or not the content has been changed based on the obtained feature information and the feature information registered in a database; and
a function of transmitting change detection information indicating a result of the determination.
